(19) United States
(12) Patent Application Publication
(10) Pub. No.: US 2001/0008388 A1
(43) Pub. Date: Jul. 19, 2001

(54) Dielectric filter having notch pattern

(76) Inventors: Dong-Suk Jun, Taejon (KR); Bon-Hee Koo, Taejon (KR); Chang-Hwa Lee, Taejon (KR); Oh-Gone Chun, Taejon (KR); Sang-Seok Lee, Taejon (KR)

Correspondence Address: JACOBSON, PRICE, HOLMAN & STERN, PROFESSIONAL LIMITED LIABILITY COMPANY, 400 Seventh Street, N.W., Washington, DC, 20004, US

(21) Appl. No.: 09/749,797

(22) Filed: Dec. 28, 2000

(30) Foreign Application Priority Data
Jan. 19, 2000 (KR) 2000-2437

(51) Int. Cl. H01P 1/201

(52) U.S. Cl. 333/202; 333/206

(57) ABSTRACT

A dielectric filter having a notch pattern includes a dielectric block, in which a ground face plated with conductive metal for all the rest portions excepting an upper face thereof and both side given portions of one side wall face connected to the upper face is formed and numerous patterns plated with the conductive metal are formed on the upper face as a non-conductive part, input electrode provided on one portion out of non-conductive portions and formed so that a signal from the outside may be inputted thereto, at least two resonators formed piercing through upper and lower faces of the dielectric block, a lower end part of which is short-circuited on a lower face as the ground face of the dielectric block, wherein two resonators are connected with each other through a pattern formed on the upper face of the dielectric block in order to resonate and wave-transfer a signal inputted through the input electrode, and output electrode provided in the rest one portion out of the non-conductive portions on one side wall face of the dielectric block, the output electrode being for outputting a signal resonated in each resonator to the outside.

### FIELD OF THE INVENTION

The present invention relates to a dielectric filter installed in a terminal of a radio communication system; and, more particularly, to a dielectric filter having a notch pattern, in which an attenuation characteristic on a stop band can be improved and simultaneously a coupling quantity control between respective resonators can become easy, by gaining a high attenuation pole even without increasing the number of resonators.

### PRIOR ART OF THE INVENTION

At these days, in order to improve a frequency efficiency in the terminals of the radio communication system such as a mobile communication, a personal communication, a satellite communication and an IMT-2000, mutually neighboring transmission and reception frequency bands are used, thus a high attenuation characteristic on a stop band is required in a filter used in such terminal.

Referring to FIGS. 1 through 3, it is briefly described a dielectric filter based on first through third embodiments of a conventional technique, as follows.

The dielectric filter based on the first embodiment of the conventional technique shown in FIG. 1 includes a dielectric block 10 and first through six resonators 11, 12, 13, 14, 15 and 16 which are formed, piercing through upper and lower faces of the dielectric block 10.

Each resonator 11 through 16 is formed by plating an inner wall face of a through-hole with conductive metal, the through-hole being formed piercing through the upper and lower faces of the dielectric block 10. All the wall faces of the dielectric block 10 excepting its upper face are plated with the conductive metal. The upper face of the dielectric block 10 is electrically opened, and the rest wall faces except the upper face of the dielectric block10 are formed as ground faces.

On the upper face of the dielectric block 10, a plurality of slots 17 for controlling a coupling quantity between two resonators formed adjacently to each other, and a reactance 18 for improving an attenuation characteristic on a stop band of the dielectric filter are formed. An inner wall face of each slot 17 is plated with conductive metal, and the coupling quantity between the resonators of the filter can be controlled by controlling a size of the slot 17. The reactance 18 connects two resonators, namely, a second resonator 12 with a fifth resonator 15, and resonators 13, 14 not connected by the reactance 18 exist between two resonators, namely, the second and fifth resonators 12, 15, which are connected by the reactance 18. This reactance 18 is composed of coil, a capacitor and a lead wire etc.

The dielectric filter based on the second embodiment of the conventional technique shown in FIG. 2 includes a dielectric block 20 having a formation of first through seventh resonators 21, 22, 23, 24, 25, 26 and 27 which are formed, piercing through upper and lower faces thereof.

A first transmission line 28 having an electric length of λ/4 is formed between the first and second resonators 21, 22, λ being a wavelength of resonance frequency. Also, A second transmission line 29 having an electric length of λ/4 is formed between the second and third resonators 22, 23. According to that, such conventional dielectric filter has numerous attenuation pole characteristic through an inverter circuit. At this time, a magnetic field coupling is formed between the respective resonators, and such respective resonators are separately tuned so as to have a desired filter characteristic.

Meantime, in case that the dielectric filter based on the second embodiment of the conventional technique is applied to a duplexer, a plural number of resonance polar points can be formed by forming numerous holes.

The dielectric filter based on the third embodiment of the conventional technique shown in FIG. 3 includes a dielectric block 30 in which an electric opening face is formed on an upper face thereof, and on its side wall and lower face, ground faces plated with the conductive metal are formed, and in which first through fourth resonators 31, 32, 33, 34 formed piercing through the upper and lower faces thereof are also provided.

On the upper face of the dielectric block 30 as the opening face, there are formed first through fourth resonator patterns 31a, 32a, 33a and 34a connected to upper parts of the respective resonators 31 through 34, and two of first metal patterns 35 provided between the second and third resonator patterns 32a, 33a and between the third and fourth resonator patterns 33a, 34a. Both end parts of the first metal pattern 35 are individually connected to both side wall faces as the ground face of the dielectric block 30. Further, a second metal pattern 36 is formed between the first and second resonator patterns 31a, 32a, and one end part of the second metal pattern 36 is connected to one side wall face of the dielectric block 30, and its another end part provides an opening part 37 which is distanced by a constant interval T from another side wall face of the dielectric block 30.

In such conventional dielectric filter, a loading capacitance is formed between the respective metal patterns 35 and the second through fourth resonator patterns 32a to 34a, and a loading capacitance is also formed between the first and second resonator patterns 31a, 32a. Herewith, the loading capacitance between the first and second resonator patterns 31a, 32a is controlled by a size of the opening part 37 formed by the second metal pattern 36. In other words, the loading capacitance between the first and second resonator patterns 31a, 32a can be controlled by controlling a size of the opening part 37.

In the dielectric filter based on the first embodiment of the conventional technique, the resonators more than three must be formed to improve the attenuation characteristic on the stop band by using the reactance, therefore, the filter becomes large-sized and it is further difficult to reduce or enlarge a size of a slot processed already. Thus, there is a difficulty in controlling a coupling quantity between the resonators after a process of the filter.

Furthermore, in case that the dielectric filter based on the conventional second embodiment is applied to a duplexer, an impedance unbalance unacceptable in an interface of transmission/reception filters occurs from an attenuation pole formed on a pass band end portion of the transmission filter coupled with the reception filter. That is, the number of the attenuation poles is restricted as a transmission zero, to thereby drop a filter characteristic on the stop band, and due to such reasons, some restriction is caused in designing the transmission/reception filters of the duplexer.

In the dielectric filter based on the conventional third embodiment, the coupling quantity can be controlled by controlling a size of the opening part formed by the second metal pattern, but the number of the resonators must be increased to improve the attenuation characteristic on the stop band. Therefore, there is also such a problem that the filter becomes large-sized.

### SUMMARY OF THE INVENTION

Therefore, it is an object of the present invention to provide a dielectric filter having a notch pattern capable of improving an attenuation characteristic on a stop band, without increasing the number of resonators, through an embodiment for gaining a coupling not only between neighboring resonators but also between resonators which are not adjacent to one another, so as to obtain a high attenuation pole on a frequency band adjacent to transmission and reception frequency.

Another object of the present invention is to provide a dielectric filter having a notch pattern capable of easily controlling a coupling between a ground face and a resonator necessary for an operation of a filter and a coupling between a resonator and a resonator.

A still another object of the present invention is to provide a dielectric filter having a notch pattern capable of miniaturizing a filter without increasing the number of resonators.

In accordance with the present invention for achieving the above objects, the dielectric filter having a notch pattern includes a dielectric block in which a ground face plated with conductive metal for all the rest portions excepting an upper face thereof and both side given portions of one side wall face connected to the upper face is formed and a plurality of resonator patterns and a plurality of metal patterns plated with the conductive metal are formed on the upper face as a non-conductive part, wherein the resonator patterns are separated from the metal patterns by predetermined distances; input electrode provided on one portion out of non-conductive portions and formed so that a signal from the outside may be inputted thereto; at least two resonators formed piercing through upper and lower faces of the dielectric block, a lower end part of which is short-circuited with a lower face as the ground face of the dielectric block, wherein two resonators are connected with each other through a pattern formed on the upper face of the dielectric block in order to resonate and wave-transfer a signal inputted through the input electrode; and output electrode provided in the rest one portion out of the non-conductive portions on one side wall face of the dielectric block, the output electrode being for outputting a signal resonated in each resonator to the outside.

### BRIEF DESCRIPTION OF THE DRAWINGS

The above and other objects and features of the instant invention will become apparent from the following description of preferred embodiments taken in conjunction with the accompanying drawings, in which:

FIG. 1 illustrates a perspective view showing a first embodiment of a dielectric filter based on a conventional technique;

FIG. 2 represents a perspective view for a second embodiment based of a dielectric filter based on the conventional technique;

FIG. 3 is a plane view showing a third embodiment of a dielectric filter based on the conventional technique;

FIG. 4 is a perspective view providing a first preferred embodiment of a dielectric filter having a notch pattern in accordance with the present invention;

FIG. 5 depicts a graph showing a frequency transfer characteristic of a dielectric filter shown in FIG. 4;

FIG. 6 presents a plane view showing a second preferred embodiment of a dielectric filter having a notch pattern in the present invention;

FIG. 7 sets forth a plane view showing a third preferred embodiment of a dielectric filter having a notch pattern in the present invention; and

FIG. 8 is a plane view showing a fourth preferred embodiment of a dielectric filter having a notch pattern in the invention.

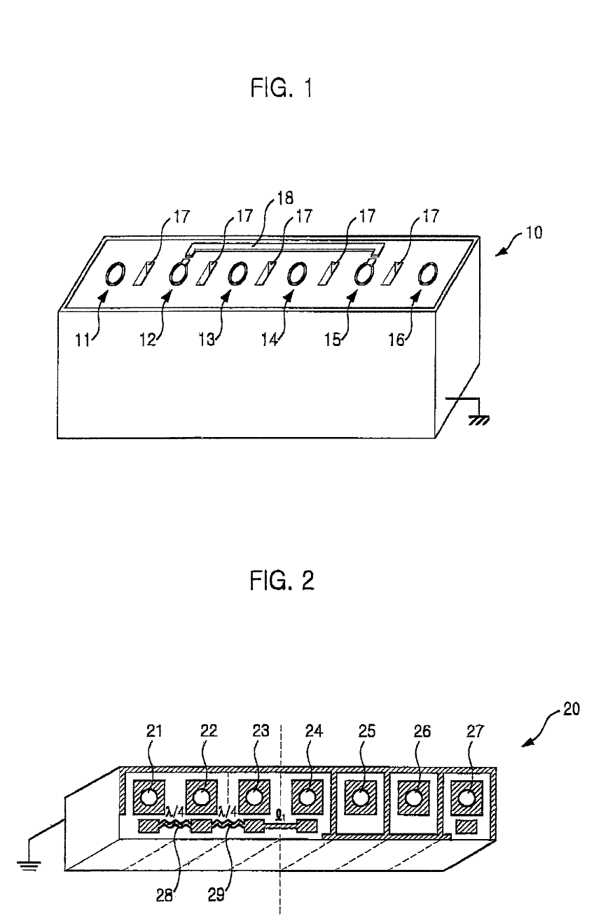

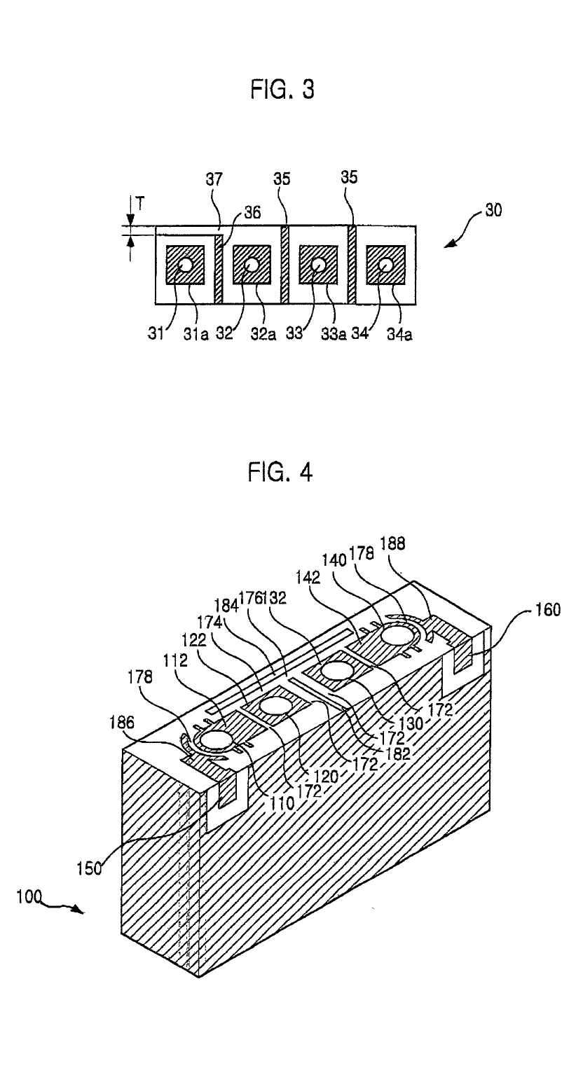

### PREFERRED EMBODIMENT OF THE INVENTION

Hereinafter, preferred embodiments of the present invention will be described in detail with reference to the accompanying drawings.

In accordance with the present invention, the preferred embodiments for a dielectric filter having a notch pattern are described in detail as follows.

As shown in FIG. 4, the dielectric filter having a notch pattern includes a dielectric block 100 plated with conductive metal for all the rest parts excepting of an upper face thereof and both side given portions of one side wall face connected to the upper face thereof; first through fourth resonators 110, 120, 130, 140 formed piercing through upper and lower faces of the dielectric block 100; and input electrode and output electrode 150, 160 respectively equipped in the part not plated with the conductive metal, the part being of one side wall face of the dielectric block 100.

The respective resonators 110 through 140 are formed by plating, with the conductive metal, inner wall faces of holes which are formed, piercing through the upper and lower faces of the dielectric block 100. An overall lower face and a constant portion of the side wall face of the dielectric block 100 are plated with the conductive metal, thus are provided as a ground face. According to that, lower parts of the respective resonators 110 through 140 provide a short-circuited end electrically connected to the lower face of the dielectric block 100 plated with the conductive metal.

In this case, on the upper face of the dielectric block 100, first through fourth resonator patterns 112, 122, 132, 142 individually connected to upper end outer circumferences of the resonators 110 through 140 are formed, and the respective resonator patterns 112 through 142 are distanced with one another to form a plurality of first opening parts 172 opened electrically between them. Herewith, a first metal pattern 182 based on a given length is formed in the first opening part 172 between the second and third resonator patterns 122, 132. The first metal pattern 182 is extended from one side wall face of the dielectric block 100 to a given portion of the dielectric block 100 upper face, and its one end part is opened electrically and its another end part is connected to the ground face. On the upper face of the dielectric block 100, a second metal pattern 184 extended from one side of the first resonator pattern 112 to one side of the fourth resonator pattern 142 is formed. Herewith, the second metal pattern 184 is distanced by a given interval from the respective resonator patterns 112 through 142 and the first metal pattern 182, to form a second opening part 174 between the respective resonator patterns 112 through 142 and the second metal pattern 184, and also form a third opening part 176 between the first metal pattern 182 and the second metal pattern 184.

On one side of the first and fourth resonator patterns 112, 142, each of input and output electrode patterns 186, 188 are distanced by a constant interval from each of patterns. The input electrode pattern 186 formed on one side of the first resonator pattern 112 is connected to input electrode 150, and the output electrode pattern 188 formed on one side of the fourth resonator pattern 142 is connected to output electrode 160. Herewith, each of fourth opening parts 178 opened electrically is formed between the first resonator pattern 112 and the input electrode pattern 186, and between the fourth resonator pattern 142 and the output electrode patter 188. Also, an input capacitance is formed by the fourth opening part 178 between the first resonator pattern 112 and the input electrode pattern 186.

An operation state of the dielectric filter based on the inventive first embodiment is described in detail as follows. In case that a microwave signal is transmitted to the input electrode 150, the microwave signal is field-coupled in the input capacitance, then is wave-transferred to the first resonator 110, and then coincides with frequency of the capacitance formed in the first, second and fourth opening parts 172, 174, 178 of the dielectric block 100 and formed on the ground and with frequency formed by the electric length λ/4 of the first resonator 110, on the neighborhood of the first resonator pattern 112, and at this time, the signal is resonated. A resonance frequency signal of the capacitance formed in the neighborhood of the electric length λ/4 of the first resonator 110 and the first resonator pattern 112 is field-coupled with the second resonator pattern 122, to be wave-transferred to the second resonator 120. The microwave signal resonated in the second resonator 120 is resonated when the signal coincides with frequency of the capacitance formed in the first and second metal patterns 182, 184 and in the second resonator pattern 122, and also with frequency of the electric length λ/4 of the second resonator 120. The resonance frequency signal of the capacitance formed in the neighborhood of the electric length λ/4 of the second resonator 120 and the second resonator pattern 122 is field-coupled with the second resonator pattern 122, to be wave-transferred to the third resonator 130. In such method, the microwave signal is wave-transferred to the third resonator 130 and the third resonator pattern 132, and then, is wave-transferred to the fourth resonator 140 and the fourth resonator pattern 142, to finally be wave-transferred to the output electrode 160.

In such dielectric filter based on the inventive embodiment, in case that the second metal pattern 184 is much smaller than the electric length λ/4 of the first and fourth resonators 110 through 140, the capacitance is formed in the concentrated integer device, to perform the field-coupling. The capacitance is formed in the second opening part 174 formed between the second metal pattern 184 and each of the resonator patterns 112, 122, 132, 142, thus an electromagnetic field coupling occurs between the second metal pattern 184 and the ground face, which influences upon a decision of the resonance frequency. Further, in case that the second metal pattern 184 has the electric length λ/4, the second metal pattern 184 performs an operation same as a transmission line. At this time, the transmission line operates as one impedance inverter, accordingly, the dielectric filter based on the inventive embodiment can operated as the dielectric filter having a notch characteristic.

Moreover, in case that the third opening part 176 between the second metal pattern 184 and the first metal pattern 182 formed on the upper face of the dielectric block is narrower than 0.4 mm (millimeters), a notch incline on the stop band lower than the pass band becomes sudden, and in case that the third opening part 176 is wider than 0.4 mm, the notch incline on the stop band lower than the pass band becomes slow.

Further, in case that the first opening part 172 between the second resonator pattern 122 and the first metal pattern 182 formed on the upper face of the dielectric block is narrower than 0.3 mm, the notch incline on the stop band higher than the pass band becomes sudden, and in case that the first opening part 172 between the second resonator pattern 122 and the first metal pattern 182 is wider than 0.3 mm, the notch incline on the stop band higher than the pass band becomes slow.

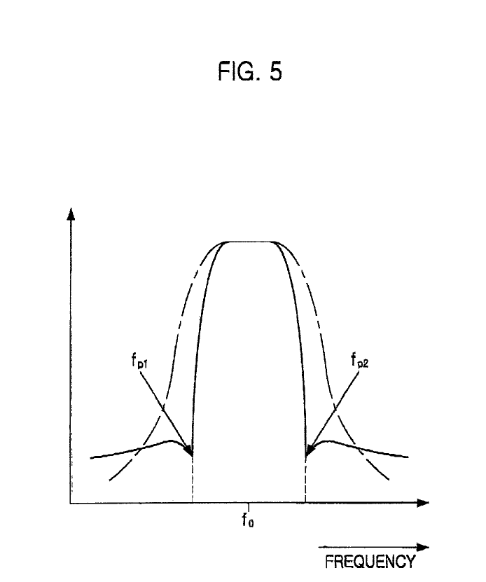

In the dielectric filter having the notch characteristic in accordance with the first embodiment of the present invention in the above-mentioned construction and operation, as shown in FIG. 5, an attenuation pole as frequency fp1 is formed in frequency lower than the pass band, and an attenuation pole as frequency fp2 is formed in frequency higher than the pass band. Therefore, a high attenuation characteristic is provided in the neighborhood of the attenuation pole frequency.

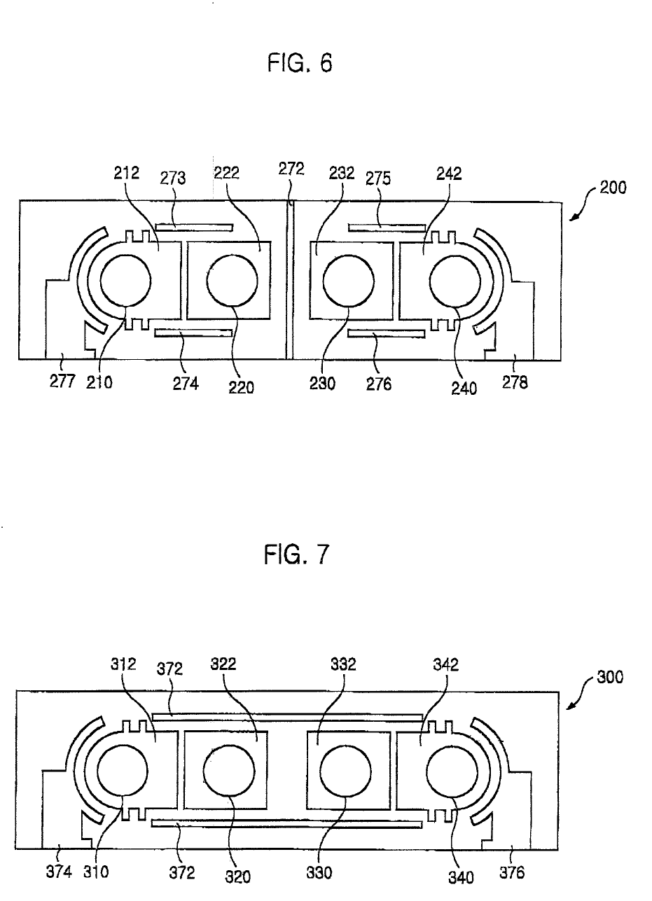

Meanwhile, the invention is not limited to the above embodiment, but can be constructed by differently providing a shape of patterns formed on the upper face of the dielectric block in the following second through fourth embodiments. With reference to FIGS. 6 through 8, the dielectric filter is described in detail in the second through fourth embodiments of the invention, referring to FIGS. 6 to 8. For reference, a detailed description for the same portions as the first embodiment will be omitted in the following.

As shown in FIG. 6, in the dielectric filter based on the second embodiment of the invention and on the upper face of the dielectric block 200 formed piercing through the upper and lower faces of the first through fourth resonators 210, 220, 230, 240, there are equipped a central metal pattern 272 for partitioning off into the first and second resonator patterns 212, 222 and the third and fourth resonator patterns 232, 242; a pair of third metal patterns 273, 274 formed, being respectively distanced by a constant interval on both sides of the first and second resonator patterns 212, 222; and a pair of fourth metal patterns 275, 276 formed, being respectively distanced by a constant interval on both sides of the third and fourth resonator patterns 232, 242. On each one side of the first and fourth resonator patterns 212, 242, input and output electrode patterns 277, 278 individually connected to input and output electrode (not shown) are formed, being distanced by a given interval from each other.

Both end parts of the central metal pattern 272 are individually connected to both side wall faces of the dielectric block 200 plated with the conductive metal, to thus cut off the electric field coupling between the second resonator pattern 222 and the third resonator pattern 232. In this embodiment, according to that, the first and second resonator patterns 212, 222, and the third and fourth resonator patterns 232, 242, are respectively coupled by the electric field with each other, and the second and third resonator patterns 222, 232 are coupled by only pure electric field.

Like this, in case that the coupling between the resonators is gained by only the pure electric field, an impedance inverter circuit between the resonators forms an inductance, therefore, one attenuation pole is provided at a position higher than the pass band. Accordingly, in the dielectric filter based on this embodiment, the coupling between the first and second resonator patterns 212, 222 and the coupling between the third and fourth resonator patterns 232, 242 can form a plurality of attenuation poles at a position lower than the pass band according to a field coupling quantity, and also, can form one attenuation pole at a position higher than the pass band by the field coupling between the second and third resonator patterns 222, 232. Therefore, the attenuation pole can be provided at the band higher or lower than the pass band.

As shown in FIG. 7, in the dielectric filter based on the third embodiment of the invention and on the upper face of the dielectric block 300 formed piercing through the upper and lower faces of the first through fourth resonators 310, 320, 330, 340, there are equipped the first through fourth resonator patterns 312, 322, 332, 342 and a pair of fifth metal patterns 372 formed, being distanced by a constant interval in both sides of the respective resonator patterns 312 through 342. On each one side of the first and fourth resonator patterns 312, 342, each of the input and output electrode patterns 374, 376 individually connected to the input and output electrode (not shown) is formed.

In this case, the field coupling is formed a little between the second and third resonator patterns 322, 332 in this embodiment of the invention. According to that, in the dielectric filter of this embodiment, the coupling between the first and second resonator patterns 312, 322 and the coupling between the third and fourth resonator patterns 332, 342 are the coupling by the electric field, and the coupling between the second and third resonator patterns 322, 332 is the coupling by only the pure electric field. Like this, in case there exists only the pure field coupling in the coupling between the resonators, the impedance inverter circuit between the resonators has one attenuation pole at a position lower than the pass band by a capacitance formation. Accordingly, in the dielectric filter based on this embodiment, the coupling between the first and second resonator patterns 312, 322 and the coupling between the third and fourth resonator patterns 332, 342 can form a plurality of attenuation poles at a position lower than the pass band according to the field coupling quantity, and also, can form one attenuation pole at a position lower than the pass band by the field coupling between the second and third resonator patterns 322, 332. Therefore, the attenuation pole can be provided at the band lower than the pass band.

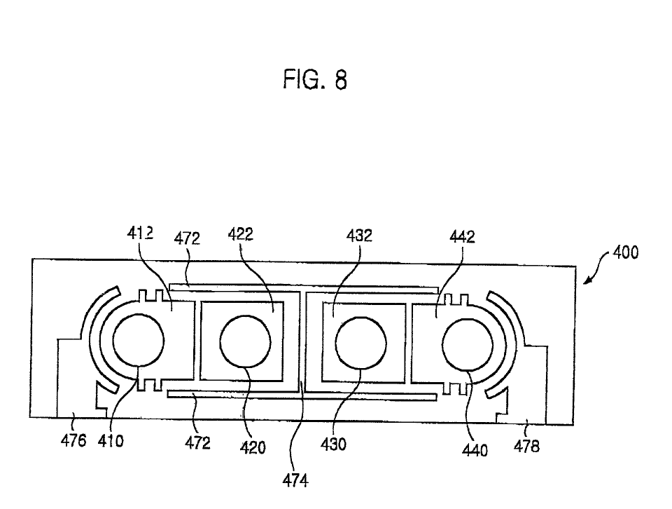

As shown in FIG. 8, in the dielectric filter based on the fourth embodiment of the invention and on the upper face of the dielectric block 400 formed piercing through the upper and lower faces of the first through fourth resonators 410, 420, 430, 440, there are equipped the first through fourth resonator patterns 412, 422, 432, 442; a pair of sixth metal patterns 472 positioned, being distanced by a constant interval in both sides of the respective resonator patterns 412 through 442; and a seventh metal pattern 474 for partitioning off the opening part provided between the second and third resonator patterns 432 by connecting centers of two sixth metal patterns 472 with each other. The metal pattern formed on the upper face of the dielectric block 400 in this embodiment is actually formed by a shape of “H”. On each one side of the first and fourth resonator patterns 412, 442, each of the input and output electrode patterns 476, 478 individually connected to the input and output electrode (not shown) is formed.

In this case, the field coupling occurs between the second resonator pattern 422 and the third resonator pattern 432 in this embodiment of the invention. According to that, in the dielectric filter of this embodiment, the field coupling occurs between the first and second resonator patterns 412, 422 and between the third and fourth resonator patterns 432, 442, and only the pure field coupling occurs between the second and third resonator patterns 422, 432. Accordingly, the dielectric filter based on this embodiment has one attenuation pole at the position lower than the pass band.

Meantime, the electric length of the pattern for coupling the resonators of the inventive dielectric filter is actually λ/4.

As afore-mentioned, in the inventive dielectric filter, the coupling between resonators influences not only upon the neighboring resonators but also upon the resonators positioned distantly, by the metal patterns formed on the upper face of the dielectric block, that is, all the resonators formed in the dielectric block are coupled with one another. Accordingly, an attenuation characteristic at the stop band is prominent, and in addition, there is an effect of an easy coupling between the resonators by changing a shape of the metal pattern.

Additionally, an attenuation pole is generated at a position higher or lower than a pass band without increasing the number of resonators, accordingly, a filter can be miniaturized and a characteristic for an insertion loss is improved by a reduction in the number of the resonators.

It will be apparent to those skilled in the art that various modifications and variations can be made in the present invention without deviating from the spirit or scope of the invention. Thus, it is intended that the present invention cover the modifications and variations of this invention provided they come within the scope of the appended claims and their equivalents.

What is claimed is:

1. A dielectric filter having a notch pattern comprising:
a dielectric block, in which a ground face plated with conductive metal for all the rest portions excepting an upper face thereof and both side given portions of one side wall face connected to the upper face is formed and a plurality of resonator patterns and a plurality of metal patterns plated with the conductive metal are formed on the upper face as a non-conductive part, wherein the resonator patterns are separated from the metal patterns by predetermined distances;
input electrode provided on one portion out of non-conductive portions and formed so that a signal from the outside may be inputted thereto;
at least two resonators formed piercing through upper and lower faces of the dielectric block, a lower end part of which is short-circuited on a lower face as the ground face of the dielectric block, wherein two resonators are connected with each other through a pattern formed on the upper face of the dielectric block in order to resonate and wave-transfer a signal inputted through the input electrode; and
output electrode provided in the rest one portion out of the non-conductive portions on one side wall face of the dielectric block, the output electrode being for outputting a signal resonated in each resonator to the outside.

2. The dielectric filter of claim 1, wherein an electric length of the pattern for coupling the resonators is λ/4.

3. The dielectric filter of claim 1, wherein the resonator patterns are connected to upper end outer circumference faces of the resonators and distanced from one another to form a plural number of first opening parts which are respectively opened electrically between them.

4. The dielectric filter of claim 1, wherein the metal patterns includes a first set of metal patterns and a second set of metal patterns.

5. The dielectric filter of claim 4, wherein the first set of the metal patterns includes:
a first pattern formed on an upper face center of the dielectric block so as to partition off one out of the first opening parts and extended from one side wall face of the dielectric block as the ground face to a constant portion of the dielectric block upper face as the non-conductive part; and
a second pattern distanced by a given interval from one side of the resonator pattern, for forming a second opening part between the respective resonator patterns and the second pattern and a third opening part between the first pattern and the second pattern.

6. The dielectric filter of claim 4, wherein the first set of the metal patterns includes:
a central pattern formed on the upper face center of the dielectric block so as to partition off the plurality of resonators, both end parts of which are individually connected to both side plated wall faces of the dielectric block;
a pair of third patterns respectively distanced by the constant interval from both sides of the resonator patterns formed on one side of the central pattern; and
a pair of fourth patterns respectively distanced by the constant interval from both sides of the resonator patterns formed on another side of the central pattern.

7. The dielectric filter of claim 4, wherein the first set of the metal patterns includes a pair of fifth patterns respectively distanced by the constant interval from both sides of the respective resonator patterns.

8. The dielectric filter of claim 4, wherein the first set of the metal patterns includes:
a pair of sixth patterns respectively distanced by the constant interval from both sides of the respective resonator patterns; and
a seventh pattern formed on the upper face center of the dielectric block, both end parts of which are individually connected to two of the sixth patterns, two resonator patterns positioned on both sides of said seventh pattern being coupled by the electric field with each other.

9. The dielectric filter of claim 4, wherein the second set of the metal patterns includes;
an input electrode pattern distanced by a constant interval from one side of the plurality of resonators and connected to the input electrode to form an input capacitance at a gap with the input electrode; and
an output electrode pattern distanced by the constant interval from another side of the plurality of resonators and connected to the output electrode to transfer a signal resonated in the resonator to the output electrode.

10. The dielectric filter of claim 3, wherein a size of said first opening part can be controlled so as to control an incline of the notch at a stop band higher than a pass band.

11. The dielectric filter of claim 5, wherein a size of said third opening part can be controlled so as to control the incline of the notch at the stop band lower than the pass band.

12. The dielectric filter of claim 6, wherein said central pattern cuts off an electric field coupling between the resonator patterns positioned on both sides thereof, so that the resonator patterns positioned on one side of the central pattern are coupled by electric field with each other and the resonator patterns positioned on another side of the central pattern are coupled by magnetic field with each other.
